(19) United States
(12) Patent Application Publication
(10) Pub. No.: US 2006/0039570 A1
(43) Pub. Date: Feb. 23, 2006

(54) Music broadcasting apparatus

(76) Inventor: Ming-Hsiang Yeh, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 10/920,337

(22) Filed: Aug. 18, 2004

(51) Int. Cl. H04R 27/00; H04M 1/22

(52) U.S. Cl. 381/82; 362/86; 381/123

(57) ABSTRACT

A music broadcasting apparatus is disclosed. The music broadcasting apparatus is inserted directly into a device, such as bulb-fixing socket or power socket, to which electric power has been supplied thereby the music broadcasting apparatus can be operated automatically through the supplied electric power. The present invention comprises an audio processing control device for processing and controlling a music or voice signal. A speaker is connected to the audio processing control device to broadcast the music or recorded voice. The audio processing control device is also connected to a connector, which is a lamp head to be mounted directly on the lamp-fixing socket or a power plug to be inserted into a socket for obtaining electric power. The connector can be connected to a lamp to provide with the illumination purpose at the same time. A switch is connected to the audio processing control device and the lamp to control the broadcasting of the music or the illumination. By using the connector, the present invention can be directly mounted without wiring. Thus, the present invention can be assembled easily, and is suitable to be mounted at a high and faraway place. Moreover, it is convenient to maintain the present invention.

### BACKGROUND OF THE INVENTION

The present invention relates to a music broadcasting apparatus, and more particularly to a connector that is mounted directly on a device, for example, a bulb-fixing socket or a power socket, to which electric power has been supplied, and no wiring is required for broadcasting music by using the device to which electric power is supplied.

An indoor apparatus for broadcasting music usually comprises a music center, a bedside audio, etc, or a high-level apparatus such as home theater. To achieve a better music broadcasting effect, or in a public place and a business place, several speakers are mounted on various indoor nooks and proper positions to fill the entire room with music. Each of these speakers must be connected to power cords, and mostly mounted on a high and faraway position. Thus, it is very complicated and inconvenient to complete the assemblage wiring. In addition, it is very inconvenient for the subsequent demounting due to apparatus damage and for the regular maintenance.

Moreover, in the store or the display place, the display of the light is very important besides the broadcasting of the pleasant music. Thus, a lamp socket may be mounted on every proper position for providing with the illumination through a lamp, wherein the lamp socket has been supplied with electric power and the music cannot be broadcasted without electric power. If these two irremovable factors for these places, namely, the music and the light, can be combined with one another, or an indoor position to which electric power has been supplied can be utilized to broadcast the music, thus numerous power cords can be omitted. Accordingly, a more valuable and convenient way to listen to the music can be provided for the user.

### SUMMARY OF THE INVENTION

The main purpose of the present invention is to provide a music broadcasting apparatus in which a connector that can be mounted on a lamp fixing socket is mounted directly on the lamp fixing socket. The present invention can be used to broadcast the music through electric power supplied by the lamp socket, and can be coupled to a lamp to provide with an illumination function at the same time. Thus, dual purposes including illumination and music broadcasting can be achieved. Accordingly, the assembling step can be accomplished readily due to no wiring. The present invention with easy maintenance is suitable to be mounted on a high and faraway position.

Another purpose of the present invention is to provide a music broadcasting apparatus. The present invention can be mounted directly on the power socket through a power plug type connector without additional electric power cord. Thus, it is convenient to assemble and maintain the present invention.

According to the aforementioned purposes of the present invention, the present invention comprises an audio processing control device to process and control a music or voice signal; an audio output device, such as speaker or earphone, connected to the audio processing control device for broadcasting the music or the recorded voice; a connector electrically, such as lamp head or power plug, connected to the audio processing control device for mounting on a lamp fixing socket or a power socket to obtain electric power; a lamp for illumination connected to the connector; and a switch connected to the audio processing control device and the lamp to control the music broadcasting and the illumination activation.

The audio processing control device comprises an analog/digital converter for analog/digital converting the inputted/outputted sound signal; a microprocessor for processing the signal data; a digital signal processor connected to the microprocessor for digitizing the signal data; a storage device, such as flash memory card or hard disk, connected to the microprocessor; and a wireless transceiver module for receiving a remote control signal or transmitting the data signal to another music broadcasting apparatus.

The present invention further comprises a timer mounted thereon to broadcast the music or the voice at a predetermined time.

The present invention further comprises a sensor mounted thereon to turn on or turn off the present invention, and a different sensor is utilized to control the broadcasting of different music and voice

Thus, the present invention can be mounted directly on several indoor lamp sockets through lamp head type connectors, or inserted into sockets through power plug type connectors for broadcasting the music. By using the control of the switch, the illumination purpose is provided at the same time. Thus, the music broadcasting apparatus with simple assemblage and maintenance is provided.

The aforementioned aspects and advantages of the present invention will be readily clarified in the hereafter description of examples of preferred embodiments of the present invention, in reference with the enclosed drawings.

The present invention intends to cover all alternatives and arrangements of these alternatives. Nevertheless, the selected preferred embodiment is described in the specification and illustrated in the accompanying drawings.

### BRIEF DESCRIPTION OF THE DRAWINGS

FIG. 1 is a schematic diagram showing an outward-appearance of a first preferred embodiment of the present invention.

FIG. 2 is a schematic diagram showing the present invention mounted on a lamp socket.

FIG. 3 is a block diagram showing a composition of the present invention.

FIG. 4 is a schematic diagram showing a second preferred embodiment of the present invention.

FIG. 5 is a schematic diagram showing a third preferred embodiment of the present invention.

FIG. 6 is a schematic diagram showing a fourth preferred embodiment of the present invention.

FIG. 7 is a schematic diagram showing a fifth preferred embodiment of the present invention.

### DETAILED DESCRIPTION OF THE PREFERRED EMBODIMENT

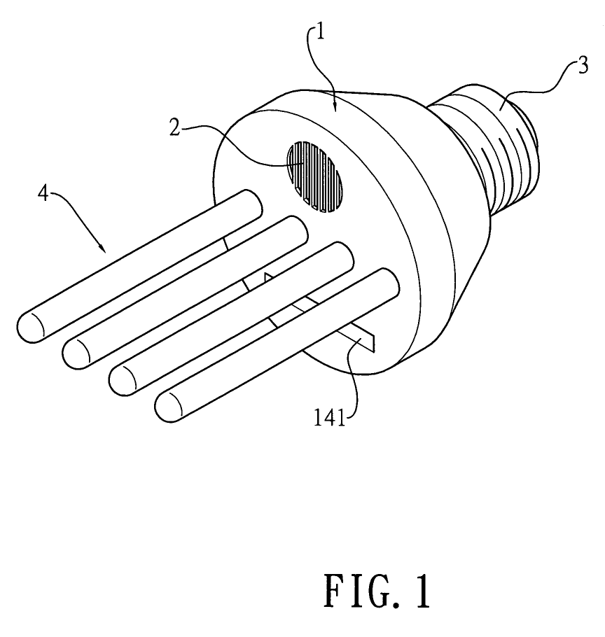

FIG. 1 is a schematic diagram showing an outward-appearance of a first preferred embodiment of the present invention. As shown in FIG. 1, an audio processing control device 1 for processing and controlling a music or voice signal is provided in the present invention.

An audio output device 2, such as speaker or earphone, is connected to the audio processing control device 1 for broadcasting the music or the recorded voice.

A connector 3 is electrically connected to the audio processing control device 1. The connector 3 is a lamp head to be mounted on a lamp socket through which electric power is supplied.

A lamp 4 is electrically connected to the lamp head 3 to provide with the illumination function.

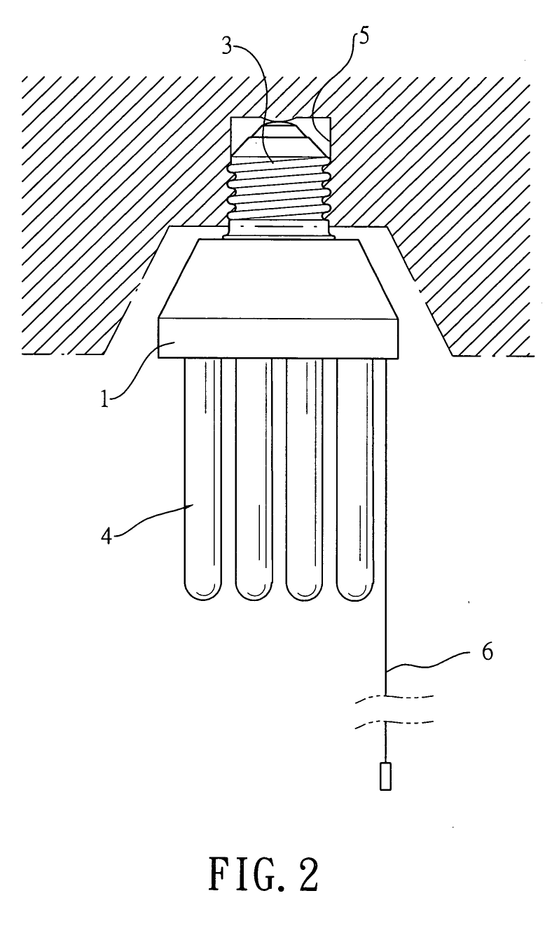

FIG. 2 is a schematic diagram showing the present invention mounted on a lamp socket. As shown in FIG. 2, the present invention is mounted on the lamp socket 5 for inputting electric power through the lamp head type connector 3. A switch is mounted on the audio processing control device 1 to control the broadcasting of the music and the voice or to control the illumination of the light. A pull cord 6 is connected to the switch so as to achieve the control purpose from a low position. The switch can be a remote control for controlling the showing of the music or the activation of light in a wireless remote way.

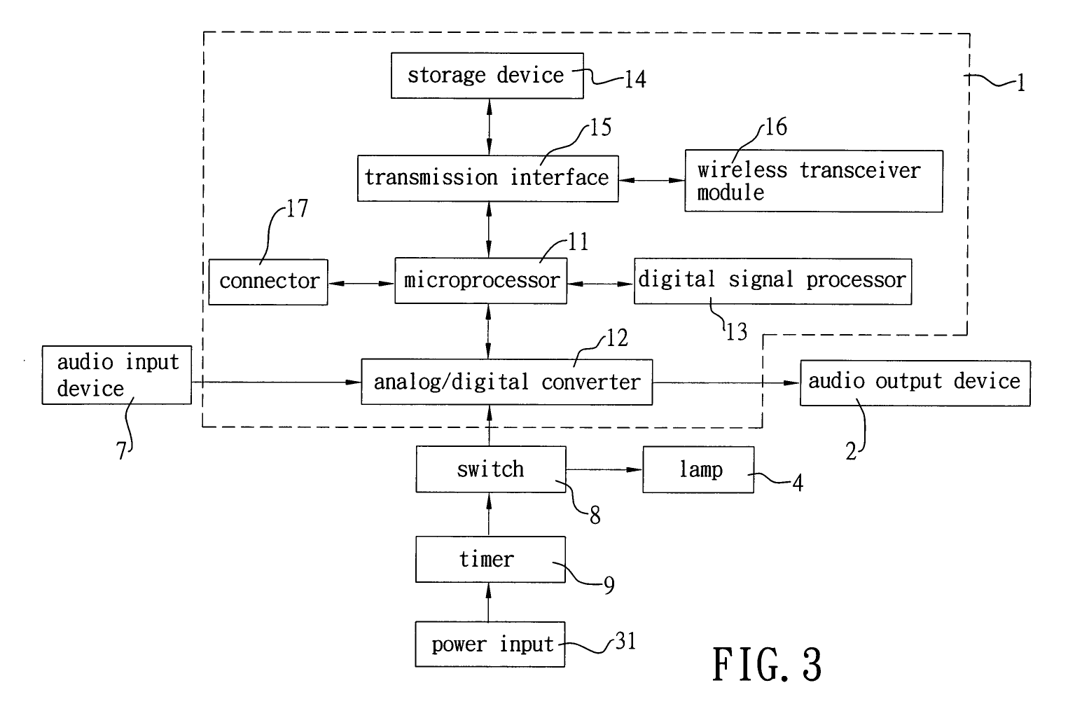

FIG. 3 is a block diagram showing a composition of the present invention. As shown in FIG. 3, the audio processing control device 1 described above comprises:

a microprocessor 11 for processing signal data;

an analog/digital converter 12 connected to the microprocessor 11 for analog/digital converting the inputted/outputted sound signal;

a digital signal processor 13 connected to the microprocessor 11 for digitizing the music and sound signals;

a storage device 14 connected to the microprocessor 11 through a transmission interface 15, wherein the storage device 14 is used to store the sound and music signal data, and can be a flash memory card or a hard disk;

a wireless transceiver module 16 connected to the transmission interface 15 for receiving a remote control signal or transmitting the data signal to another music broadcaster disposed on other location, wherein the wireless transceiver module 16 comprises blue tooth module, wireless frequency modulation system, infrared ray wireless transmission, Wifi, Radio Frequency Identification Code (RFID), and so forth, wherein the RFID can execute an instruction, for example, an auto-display instruction, an auto-monitoring instruction, or the like, automatically by using its identification function; and

a connector 17 connected to an apparatus such as computer for transmitting the audio data, wherein the connector 17 is a USB interface.

The present invention further comprises an audio input device 7 connected to the audio processing control device 1, wherein the audio input device 7 can be a microphone for inputting sound or a connecting line for inputting music signal.

The present invention comprises a switch 8 connected to the audio processing control device 1 and a lamp 4 to control the activation of the music and the light. A timer 9 is connected to the switch 8 to automatically turn on the switch 8 at a predetermined time for showing the music or the voice, for example, “Good Morning” in the morning, or “Merry Christmas” on a special day such as Christmas day. A power input 3 1 is provided for the present invention through the mounting of the lamp head type connector 3 on the lamp socket.

The present invention further comprises a sensor connected to the microprocessor 11 to transmit a sensor signal to the microprocessor 11 to turn on or turn off the showing of the music. In addition, various sensors can be utilized to control the showing of various music or voices, for example, “Warning”, “Welcome”, and the like.

According to the above description, the lamp head is utilized to enable the present invention to be mounted directly on the lamp socket, thus no wiring is required. In other words, the present invention to which electric power has been supplied can be mounted readily and directly to achieve the music broadcasting purpose. The present invention is especially suitable for operation on a high and faraway place. Since there is no wiring issue, the replacement can be reached by using a tall pole, namely, it is not necessary to climb to a high place, and the maintenance of the present invention becomes easier. The present invention combines the lamp illumination with the music broadcasting. In other words, when the lamp is activated the lamp will show the music at the same time. The present invention is suitable for various situations. When the present invention is mounted on various indoor locations, the wireless transceiver modules can be utilized to transmit the audio data to one another, or a power cord that is complied with powerline home networking specification (Homeplug) can be utilized to transmit the audio data. Thus, each apparatus located on different place provides with the same music or voice so as to broadcast the same content by connecting to one another.

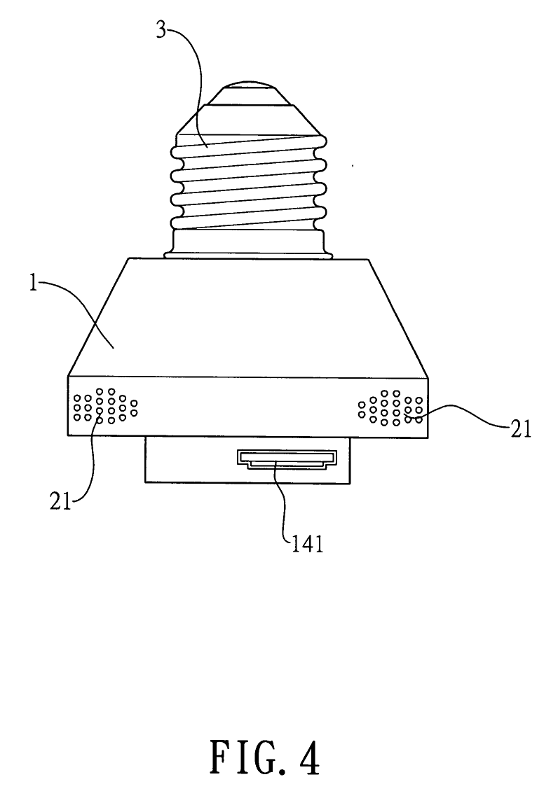

FIG. 4 is a schematic diagram showing a second preferred embodiment of the present invention. As shown in FIG. 4, the lamp is not included in this preferred embodiment. A lamp head type connector 3 is electrically connected to the audio processing control device 1 on which a speaker 21 and a memory card slot 141 for receiving a memory card to access data are mounted.

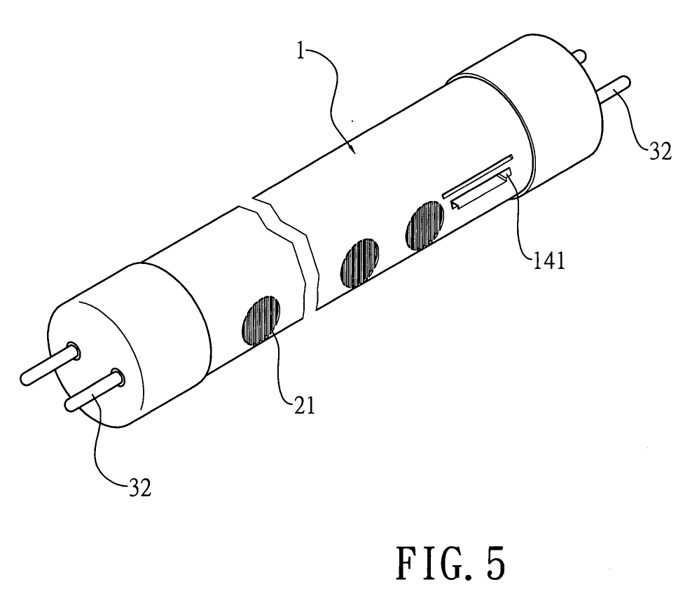

FIG. 5 is a schematic diagram showing a third preferred embodiment of the present invention. As shown in FIG. 5, a fluorescence lamp type apparatus is provided. The audio processing control device 1 is in the form of a fluorescence tube. Pins 32 are mounted on both ends of audio processing control device 1 for inserting into a lamp socket to electrically connect to a power source. A speaker 21 for showing the music and a memory card slot 141 for accessing the music and voice data are mounted on the audio processing control device 1.

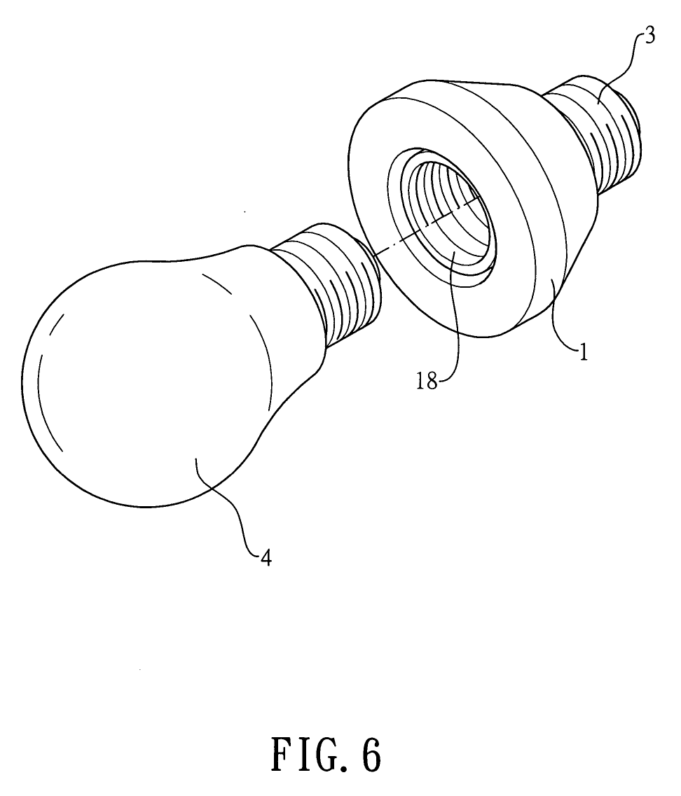

FIG. 6 is a schematic diagram showing a fourth preferred embodiment of the present invention. As shown in FIG. 6, a lamp head type connector 3 to be mounted on the lamp socket is connected to one end of the audio processing control device 1, and a lamp-fixing socket 18 for fixing an existent lamp such as bulb is mounted on the other end of audio processing control device 1. Accordingly, the existent lamp can be upgraded to provide with the functions of illumination and music broadcasting.

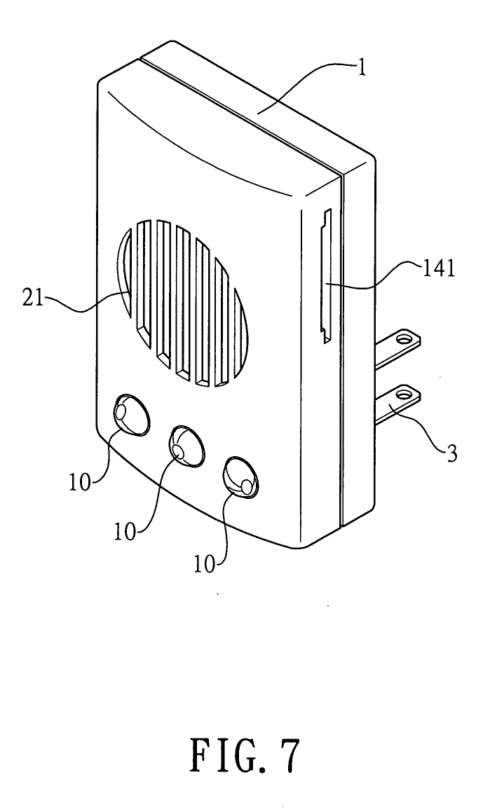

FIG. 7 is a schematic diagram showing a fifth preferred embodiment of the present invention. As shown in FIG. 7, the connector 3 is a power plug that can be plugged into a power socket, thus the present invention can broadcast the music without wiring. Since no wiring and maintenance are required for the present invention, it is simple and convenient to assemble thereof. In addition, if electric power is supplied, the present invention can be operated automatically. It is more convenient to assemble and use the present invention, and quite suitable for assembling at a high and faraway place. A speaker 21 is mounted on the main body of the audio processing control device 1 to broadcast the music. A memory card slot 141 is mounted on the sidewall of the audio processing control device 1 for accessing the audio data. Sensors 10 in various angles are mounted in the front end of the audio processing control device 1 for inputting various sensor signals so as to produce various music or voices.

Therefore, as is understood by a person skilled in the art, the present invention achieves the aforementioned purpose according to the above description and satisfies requirements of patent law. The application for a patent is therefore submitted.

As is understood by a person skilled in the art, the foregoing preferred embodiments of the present invention are illustrated of the present invention rather than limiting of the present invention. It is intended that various modifications and similar arrangements be included within the spirit and scope of the appended claims, the scope of which should be accorded the broadest interpretation so as to encompass all such modifications and similar structure.

What the invention claimed is:

1. A music broadcasting apparatus comprising:
an audio processing control device to process and control a music or sound signal;
an audio output device connected to the audio processing control device for broadcasting the music or the recorded voice;
a connector electrically connected to the audio processing control device for being mounted on a device to which electric power has been supplied to obtain electric power; and
a switch connected to the audio processing control device to control the broadcasting of the music.

2. The music broadcasting apparatus of claim 1, wherein the audio output device is a speaker.

3. The music broadcasting apparatus of claim 1, wherein the connector is a lamp head to be mounted on a lamp-fixing socket.

4. The music broadcasting apparatus of claim 1, wherein the connector is a power plug to be inserted into a power socket.

5. The music broadcasting apparatus of claim 3, wherein further comprises a lamp connected to the switch.

6. The music broadcasting apparatus of claim 1, wherein further comprises a bulb-fixing socket for receiving an existent bulb.

7. The music broadcasting apparatus of claim 1, wherein the audio processing control device comprises an analog/digital converter for analog/digital converting the inputted/outputted sound signal; a microprocessor for processing signal data; a digital signal processor connected to the microprocessor for digitizing the signal data; a storage device connected to the microprocessor; and a wireless transceiver module for receiving a remote control signal or transmitting the audio data to another music broadcasting apparatus.

8. The music broadcasting apparatus of claim 1, wherein further comprises a timer to broadcast the music at a predetermined time.

9. The music broadcasting apparatus of claim 1, wherein further comprises a microphone for inputting the sound.

10. The music broadcasting apparatus of claim 1, wherein further comprises a sensor to turn on or turn off thereof, and a different sensor is utilized to control the broadcasting of different music and voice.
